(19) United States
(12) Patent Application Publication
(10) Pub. No.: US 2013/0290355 A1
(43) Pub. Date: Oct. 31, 2013

(54) Method and System of Selecting Business Object

(71) Applicant: ALIBABA GROUP HOLDING LIMITED, Grand Cayman (KY)

(72) Inventor: Xiaozhen Fu, Hangzhou (CN)

(73) Assignee: Alibaba Group Holding Limited, Grand Cayman (KY)

(21) Appl. No.: 13/871,836

(22) Filed: Apr. 26, 2013

(30) Foreign Application Priority Data
Apr. 28, 2012 (CN) 201210135167.X

(51) Int. Cl. G06F 17/30

(52) U.S. Cl. CPC G06F 17/30699
USPC 707/754

(57) ABSTRACT

Techniques for selection of business objects are described herein. These techniques may include transmitting, by a computing device, a search request to a server and receiving multiple business objects corresponding to the search request. The computing device may then present the multiple business objects using one or more attribute value indicators indicating a range of attribute values associated with the multiple business objects. After detecting movement of attribute value indicators, the computing device determines a filtering range based on the movement, and then transmits the filtering range to the server to request filtered business objects of the multiple business objects.

### CROSS REFERENCE TO RELATED PATENT APPLICATIONS

This application claims priority to Chinese Patent Application No. 201210135167.X, filed on Apr. 28, 2012, entitled “Method and System of Selecting Business Object,” which is hereby incorporated by reference in its entirety.

### TECHNICAL FIELD

This disclosure relates to computer and internet technologies. More specifically, the disclosure relates to methods and apparatuses for selection of business objections.

### BACKGROUND

With the era of electronic information, Internet plays an important role in our lives. People can quickly and timely obtain different kinds of information. Internet applications provide conveniences to people's lives and works and become a popular technique.

Due to the popularity of Internet, it now becomes the basic method of carrying business and the business implemented by internet is called the Internet business. Currently, there are many types of Internet business and the servers deployed in the network are mainly used to implement the corresponding business. For example, on the popular trade websites, the network servers provide different kinds of trade services, including the physical trade services, information trade services, and etc., to the users. On such websites, the users display the description information of the business objects (e.g., products) on the website for other users to select. For instance, when the business objects are physical objects, the description information displayed on the website can be the photos, names, usages, prices, and etc., of the physical objects, and when the business objects are information, the description information displayed on the website can be the abstract or keyword segments of the information.

After users access the webpage servers through the terminals, the webpage servers display the list containing the business objects which can be provided to the users through the webpages, and the users select the business objects displayed on the webpages to proceed further business, for example, sending a request of obtaining the object to the website server and the website server can implement the obtaining of the object for the user based on the regulated process. The regulated process may be different, such as asking the user to login, or asking the user to pay a certain fee to the object.

Currently, as Internet is very popular, the numbers of business objects provided by Internet are great. To make the user select the business object conveniently, generally the server provides the function of filtering business objects, which a filtering interface for the user to input the selection criteria is provided on the set location of a webpage. For better understanding, FIG. 1 presents a diagram of a filtering interface of the business object A. The filtering interface provides the sorting function based on the attribute 1, the attribute 2 and the default sequence of the business object. In other words, the user can click the “sort based on attribute 1”, sort based on attribute 2” or “sort based on the default sequence” buttons to implement the corresponding sorting functions. On this basis, after sorting based on the sequence attributes of the business objects, the attribute values of the attributes can be further filtered. The users can use the “input boxes of ranges of the filtering attribute values” buttons to further filter the business objects of the attribute values falling into the filtering ranges. The users click the “confirm” buttons to submit the filtering criteria after inputting the ranges of the filtering attributes.

By the function of filtering business objects provided by servers, users can filter the business objects based on the relevant attributes of the business objects to be obtained, and so as to reduce the numbers of searching business objects and select the business objects which meet the users' requirements. As the function of filtering business objects is getting popular among users, there may be some problems existing in applications:

For the users, the operations are complicated and the input efficiency is low because the above filtering process requires the users to determine the filtering interface on the webpage and to input the attribute values in the corresponding input boxes of ranges of the filtering attribute values to the attributes which are used as the attributes of the sorting dimensions. As for the servers, they need to receive the ranges of the filtering attribute values inputted by the users, and filter the business objects meeting the criteria after identifying the ranges and display the results on the webpage by refreshing the pages. As such, the whole filtering process takes a longer time and reduces the efficiency of filtering the business objects.

### SUMMARY

The present disclosure presents a method and a device of filtering business objects. With the present disclosure, the user operations are simplified, the time of filtering process is shortened, and the efficiency of filtering business objects is increased. This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

One aspect of the present disclosure, concerns a method of filtering business objects comprising determining that a user terminal has performed an operation of triggering of filtering business objects; displaying a filtering slip on a current webpage, wherein the filtering slip displays attribute values, and the displayed attribute values are determined based on attribute values of sorting attributes corresponding to business objects contained in the current webpage; determining a filtering range of the attribute values of sorting attributes according to operations performed by attribute values displayed on the filtering slip; and sending the determined filtering rage information to a webpage server.

Another aspect of the present disclosure concerns, a method of filtering business objects comprising receiving a filtering range of business objects contained in a webpage which is sent from a user terminal, wherein the range of filtering of attribute values of sorting attributes is determined according to operations performed by attribute values displayed on a filtering slip, and the attribute values displayed on the filtering slip are determined by attribute values of sorting attributes corresponding to business objects contained in a current webpage; according to the range of filtering of the received attribute values of sorting attributes, determining business object data corresponding to the range of filtering, and sending the determined business object data to the user terminal.

Another aspect of the present disclosure concerns, a device of filtering business objects comprising a trigger operation determination unit for determining that a user terminal has performed an operation of triggering of filtering business objects; a filtering slip displaying unit for, after the trigger operation determination unit, determining the operation displaying a filtering slip on a current webpage, wherein the filtering slip displays attribute values, and the displayed attribute values are determined based on attribute values of sorting attributes corresponding to business objects contained in the current webpage; a filtering range determination unit for determining a filtering range of the attribute values of sorting attributes according to operations performed by attribute values displayed on the filtering slip; and a sending unit for sending the determined filtering rage information to a webpage server.

Another aspect of the present disclosure concerns, a device of filtering business objects comprising a receiving unit for receiving a range of filtering of attribute values of sorting attributes of business objects contained in a webpage which is sent from a user terminal, wherein the range of filtering of attribute values of sorting attributes is determined according to operations performed by attribute values displayed on a filtering slip, and the attribute values displayed on the filtering slip are determined by attribute values of sorting attributes corresponding to business objects contained in a current webpage; a business object filtering unit for, according to the range of filtering of the received attribute values of sorting attributes, determining business object data corresponding to the range of filtering, and sending the determined business object data to the user terminal; and a sending unit for sending the business object data determined by the business object filtering unit to the user terminal.

Other features and advantages of the present disclosure will be illustrated in the following specification and will become apparent.

### BRIEF DESCRIPTION OF THE DRAWINGS

The Detailed Description is described with reference to the accompanying figures. The use of the same reference numbers in different figures indicates similar or identical items.

FIG. 1 is a diagram of an interface of filtering business objects in the conventional technology.

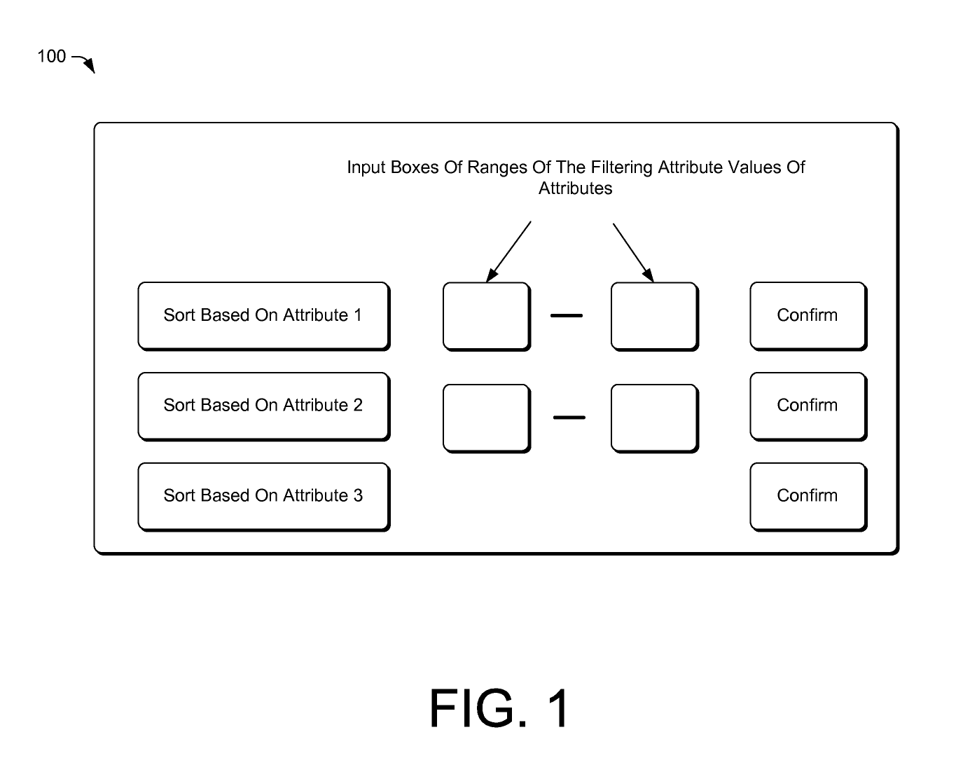

FIG. 2 illustrates an example environment for business object determination.

FIG. 3 is a flow chart of implementing the process of webpage displaying by the communication system of FIG. 1 in accordance with embodiments of the present disclosure.

FIG. 4 is a flow chart of a method of filtering business objects in accordance with embodiments of the present disclosure.

FIG. 5 is a diagram of displaying attribute values on a filtering bar in accordance with embodiments of the present disclosure.

FIG. 6 is another diagram of displaying attribute values on a filtering bar in accordance with embodiments of the present disclosure.

FIG. 7 is a flow chart of a client terminal determining a filtering range of the attribute values of sorting attributes according to operations of dragging the attribute values in accordance with embodiments of the present disclosure.

FIG. 8 is a curve diagram presenting the distribution status of the attribute values on the rolling bar in accordance with embodiments of the present disclosure.

FIG. 9 is a diagram of a device of filtering business objects in accordance with embodiments of the present disclosure.

FIG. 10 is another diagram of a device of filtering business objects in accordance with embodiments of the present disclosure.

FIG. 11 is yet another diagram of a device of filtering business objects in accordance with embodiments of the present disclosure.

FIG. 12 is yet another diagram of a device of filtering business objects in accordance with embodiments of the present disclosure.

FIG. 13 is yet another diagram of a device of filtering business objects in accordance with embodiments of the present disclosure.

### DETAILED DESCRIPTION

In order to improve the efficiency of the filtering process, the present disclosure provides a method and a device of filtering business objects. The disclosure can be used by users to search and filter business objects and can be implemented as a method or a product. In conjunction with the figures, the preferred embodiments of the present disclosure are described. It should be understood that the preferred embodiments are merely for describing and explaining the present disclosure and are not intended to limit the present disclosure. The embodiments and the features of embodiments of the present disclosure can be combined without generating conflicts.

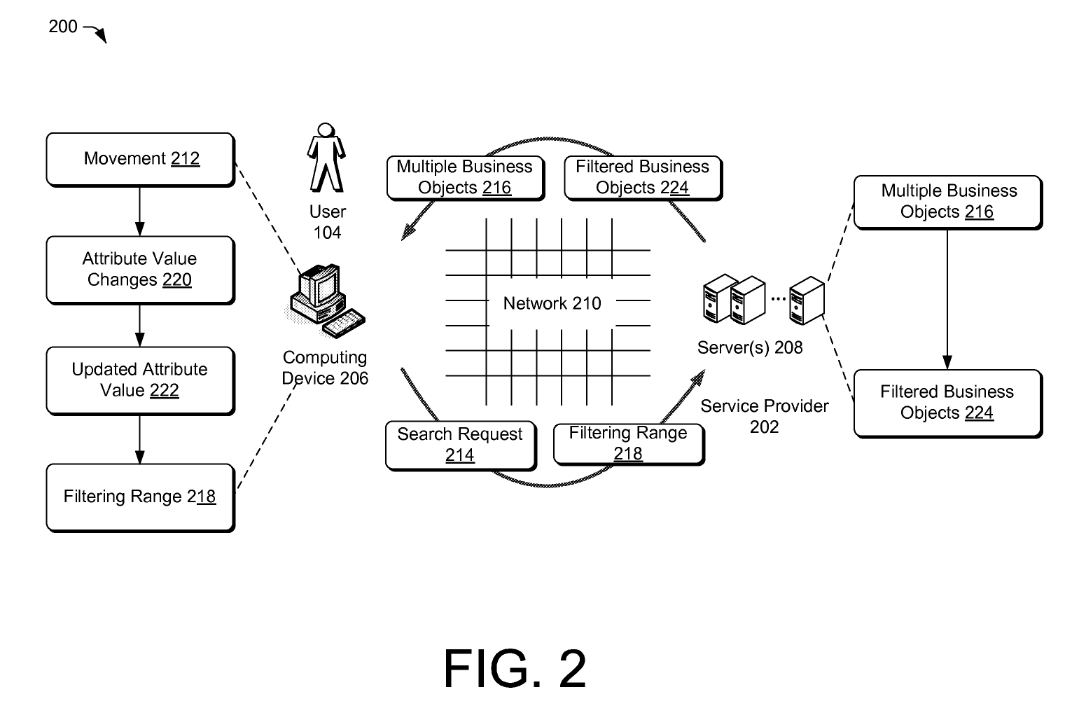

FIG. 2 illustrates an example environment 200 that includes computing device(s) and server(s) for determining business objects. The environment 200 may include a service provider 202 that provides online services. These services may be associated with online storage services, search services (e.g., shopping searches), database service, and application services. A user 204 may operate a computing device 206 to exchange information with one or more server(s) 208 hosted by the service provider 202.

The computing device 206 may be a mobile telephone, a smart phone, a tablet computer, a laptop computer, a netbook, a personal digital assistance (PDA), a gaming device, a media player, or any other mobile computing device that includes a display and can connect to one or more network(s) 210 to interact with the server 208.

The network(s) 210 may include wired and/or wireless networks that enable communications between the various computing devices described in the environment 200. In some embodiments, the network(s) 210 may include local area networks (LANs), wide area networks (WAN), mobile telephone networks (MTNs), and other types of networks, possibly used in conjunction with one another, to facilitate communication between the various computing devices (i.e., the computing device 206 and the server 208).

In accordance with some embodiments, the computing device 206 may transmit a search request 214 to the server 208. For example, the user 204 may provide a keyword to search multiple business objects. The multiple business objects may include information of multiple items associated with one or more business entities. For example, the multiple business entities may be merchants using certain services associated with the service provider 202. In some instances, the service provider 202 may provide internet-based Electronic Commerce businesses that cover business-to-business online marketplaces, retail and payment platforms, and data-centric cloud computing services.

After receiving the search request, the server 208 may perform searches using the keyword to determine multiple business objects 216. For example, the multiple business objects 216 may include information of multiple items associated with one or more business entities. The server 208 may return the multiple business objects 216 to the computing device 206.

In some embodiments, the computing device 206 may present the multiple business objects 216 using one or more attribute value indicators, which are discussed in more detailed below. For example, the computing device 206 may display at least one of images, names, usages, prices or descriptions associated with multiple items associated with one or more business entities together with one or more attribute indicators. These indicators may indicate a range of attribute values associated with the multiple business objects 216. In some instances, individual business object of the multiple business objects include an item associated with one or more business entities. For example, the attribute values may include a price and credibility associated with the multiple business objects 216.

The computing device 206 may determine a filtering range 218 based on a movement 212 of an attribute value indicator. In these instances, the computing device 106 may detect the movement 212 of the attribute value indicator, and then determine the filtering range 218. For example, the computing device 206 may display attribute value indicators in a user interface to allow the user 204 to change the filter range 218 by moving one or more attribute value indicators.

In some embodiments, based on the movement 212, the computing device 206 may determine an amount of attribute value changes 220 based on the movement 212, update an attribute value of the attribute values that corresponds to the attribute value indicator, and determine the filter range 218 based on the updated attribute value 222, which are discussed in greater detail below. In some instances, the filtering range 218 includes an attribute value of sorting attributes of the multiple business objects 216. For example, the computing device 206 may receive a sorting request including a sorting attribute, and sort the multiple business objects 216 based on the sorting attribute.

In some embodiments, the computing device 206 may transmit the filter range 218 to the sever 208. The server 208 may determined filtered business objects 224, and transmit the filtered business objects 224 to the computing device 206, which then presents the filtered business objects 224 using one or more updated attribute value indicators.

### Embodiment 1

The present Embodiment 1 provides a method of filtering business objects. Such a method can be used in a scenario that a user terminal accesses a webpage. Specifically, it can be in a process that a user terminal filters the business objects of the webpage to be accessed.

The method of filtering business objects provided in Embodiment 1 can be applied to different servers and/or client terminals of a network, for example, the website servers (e.g., the server 208) and/or client terminals (e.g., the computing device 206) of implementing Internet businesses. Though the types of the servers and/or client terminals may vary with the businesses, the method provided by Embodiments can be applied to any kind of servers and/or client terminals.

In the method of filtering and/or recommending information provided by Embodiment 1, a triggering operation of triggering the filtering function based on the attribute values of a filtering bar can be pre-set, and the triggering operation can be monitored by the client terminal. If the triggering operation occurs, the client terminal activates the filtering function based on the attribute values of a filtering bar. Specifically, the triggering operation can be set by a server, or by a user through a client terminal of a user terminal. For example, the triggering operation can be set as a type that a user can easily operate. For example, for a terminal supporting a touch screen, the triggering operation can be set to correspond with the user clicking the filtering bar on a webpage or a specific location of the touch screen; for a terminal supporting a G-sensor, the triggering operation can be set to correspond with the user changing the location of the terminal to a set status (such as turning the terminal to a pre-set angle or the user shaking the terminal for a pre-set number of times, etc.); for a normal terminal (for example, not supporting a touch screen, a G-sensor, etc.), the triggering operation can be set to correspond with the user clicking a specific location of a webpage through the keyboard of the terminal. It should be understood that the description of the triggering operations are exemplary only. In applications, the triggering operations can be set with flexibility. After setting the operation types of the triggering operation, a mapping relationship between the triggering operation and the filtering function based on the attribute values of the filtering bar can be built, so that the server can activate the filtering function based on the attribute values of the filtering bar according to the monitored triggering operation.

The filtering bar mentioned in the embodiments of the present disclosure can be a vertical bar which can be moved under control and implemented on a webpage. The vertical bar can be controlled by a mouse. In a terminal supporting a touch screen, the vertical bar can be controlled by touching. Preferably, the filtering bar can be composed of a rolling block and a rolling arrow. By moving the filtering bar, the functions such as switching pages, adjusting the work area, can be implemented. In applications, the filtering bar can be implemented by the working principles of a rolling bar of a webpage. For example, the filtering bar can be implemented by the rolling bar of a webpage to reduce the complexities of implementations.

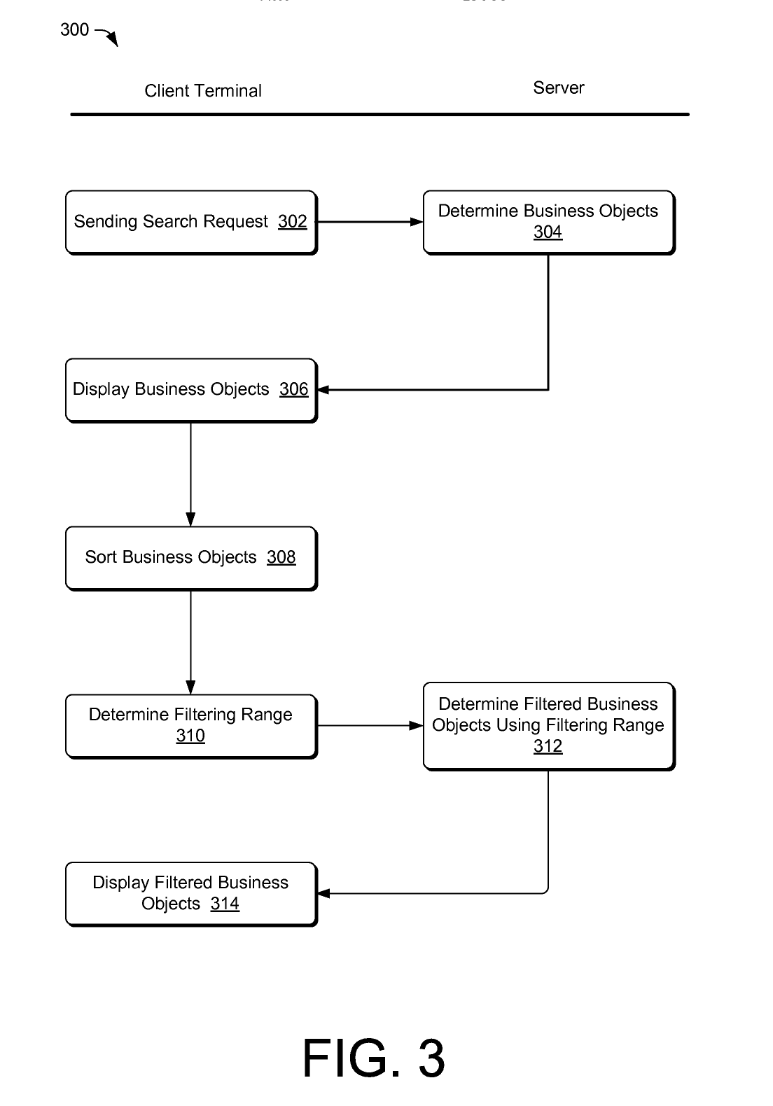

FIG. 3 illustrates an example flow chart 300 for implementing the process of webpage displaying by the communication system of FIG. 2. At 302, a user sends a search request through a client terminal of the user terminal to a webpage server. The search request carries the keywords of the requested business objects, which can be, for example, the attributes, such as the name, the usage, etc., of the business object.

At 304, after receiving the search request sent from the client terminal, the webpage server determines the corresponding business object according to the search request and sends the determined business object to the client terminal. Determining corresponding business object according to the search request refers to determining the business object data matching the keyword contained in the search request.

At 306, the client terminal receives business object data and displays business objects corresponding to the business object data through a webpage.

At 308, the client terminal receives a sorting request submitted by the user through the user terminal, and sorts business objects on the webpage according to sorting attributes of the sorting request. The sorting attribute can be at least one attribute selected from a plurality of attributes corresponding to business objects. For example, the selected attribute can be one attribute. For example, the attributes corresponding to business objects include the price, the creditability of the provider of the business objects, the positive rate percentage of the business objects, the number of times of the business objects being obtained, etc. A sorting attribute which the user chooses to use for sorting to display the business objects in a sequence on the webpage can be selected from these attributes. For example, if the price is chosen as the sorting attribute, the business objects are sorted based on the prices (high to low or low to high).

At 310, the user terminal monitors that the user triggers the filtering operation of the attribute values of sorting attributes, activates the filtering function of the attribute values, and sends the determined filtering range information to the webpage server. The filtering range refers to a range of the attribute values of sorting attributes of the business objects contained in the webpage. The details of the implementation process of the filtering function of the attribute values will be described in the following embodiments and are omitted here for clarity.

At 312, after receiving the filtering range, the webpage server determines the business object data corresponding to the filtering range according to the received filtering range of the attribute values of sorting attributes, and sends the determined business object data to the client terminal of the user terminal.

At 314, the client terminal receives the business object data determined by the webpage server and displays the business objects corresponding to the business object data to the user through a webpage.

Further, Embodiment 1 provides an example method, in which after performing the aforementioned operations 306 and/or 314, an operation is further performed: displaying a number of business objects contained in the current webpage in a set location of a webpage.

By performing the aforementioned steps, the user can determine if further filtering is necessary according to the number of business objects displayed on the webpage. The number of business objects can be determined according to the business object data, and specifically, the number of business objects can be determined according to the business object labels contained in the business object data.

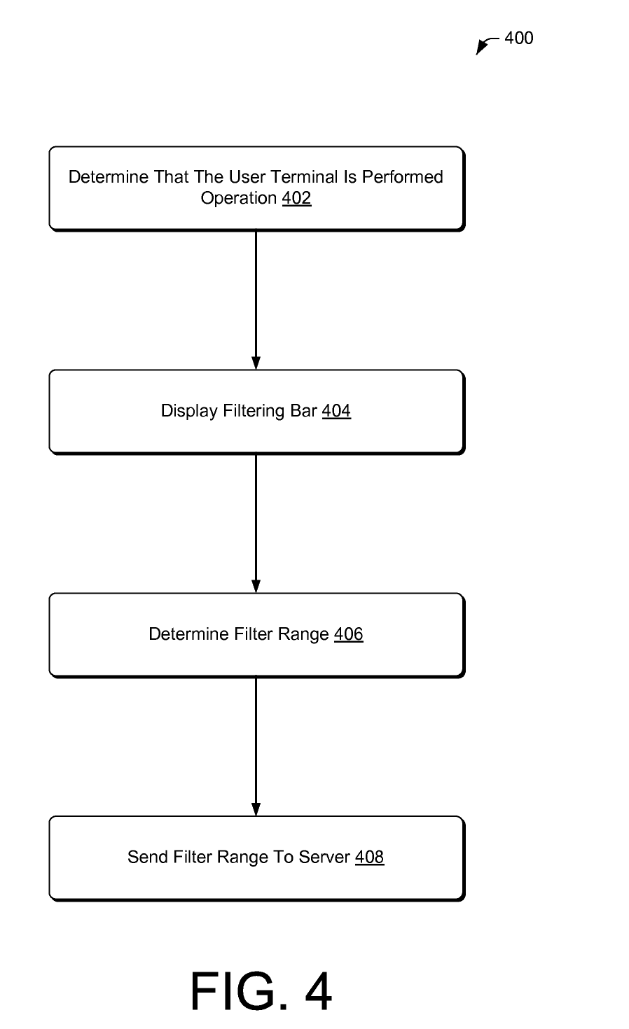

Further, Embodiment 1 provides an example method, which presents the specific implementation process of operation 310. FIG. 4 illustrates an example flow chart 400 for a process of filtering business objects provided by Embodiment 1. At 402, the client terminal of the user terminal determines that the user terminal has performed a set operation, wherein the set operation is the operation of triggering of filtering business objects.

At 404, the client terminal displays a filtering bar used for adjusting a filtering range of attribute values on a current webpage.

In some instances, the attribute values are displayed on the filtering bar and the displayed attribute values are determined according to the attribute values of sorting attributes corresponding to the business objects contained on the current webpage. In some instances, the sorting attributes can be set with flexibility. For example, the sorting attributes can be the attributes chosen by the user for sorting the business objects of the webpage (i.e., the sorting attributes contained in the sorting request submitted by the user in Step 308). If the user does not chose the attribute for sorting the business objects of the webpage, the default attributes can be chosen as the sorting attributes. The default attributes, for example, can choose other attributes which are chosen by other users to be used as the attributes for sorting the business objects of the webpage.

In some instances, the attribute values of sorting attributes corresponding to the business objects contained on the current webpage can be obtained from a system database.

At 406, the filtering range of the attribute values of sorting attributes is determined according to operations performed by attribute values displayed on the filtering bar.

In some instances, the operations performed by attribute values displayed on the filtering bar generally comprise an operation that at least one attribute value is dragged vertically along with the filtering bar. The details of determining the filtering range of the attribute values of sorting attributes will be provided in the following embodiments and are omitted for clarity.

At 408, the determined filtering rage information is sent to a webpage server.

By performing the process illustrated in FIG. 4, the client terminal can display the attribute values chosen from the attribute values of sorting attributes of the business objects contained on a webpage to a user through a filtering bar, determine the filtering range of the attribute values of sorting attributes based on the operations performed by the user for the attribute values displayed on the filtering bar, and ask the server to send the business object data matching with the filtering range to the user, according to the filtering range. The process eliminates the operations that the user inputs filtering criteria in the specified input box of a webpage and simplifies the user's operations. The time of filtering process is shortened, and the efficiency of filtering business objects is increased.

Further, Embodiment 1 provides an example method, which presents the specific implementation process of operation 404 contained in the process shown in FIG. 4. Specifically, when the client terminal displays a filtering bar used for adjusting a filtering range of attribute values on a current webpage, it needs to determine the attribute values shown on the filtering bar according to the attribute values of sorting attributes corresponding to the business objects contained on the current webpage. In some instances, the client terminal displays at least two attribute values of the attribute values on the filtering bar according to attribute values of sorting attributes corresponding to business objects contained in the current webpage.

In some instances, the at least two displayed attribute values comprise the maximum attribute value and the minimum attribute value of the attribute values corresponding to the business objects contained on the current webpage. Under such a condition, the maximum attribute value and the minimum attribute value can be displayed on two terminals of the filtering bar for user's adjustment.

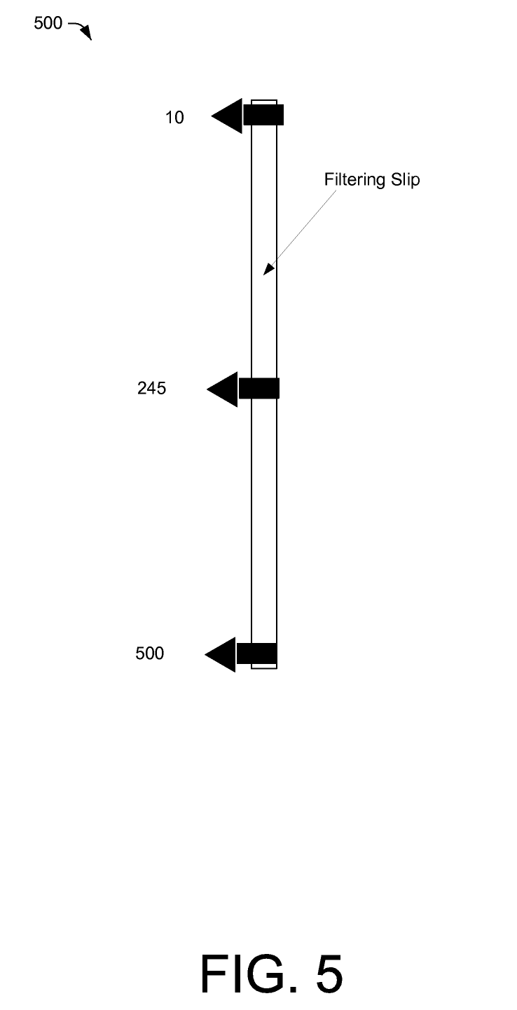

If the filtering bar displays more than two attribute values which contain the maximum attribute value and the minimum attribute value, the displayed attribute values other than the maximum attribute value and the minimum attribute value can be displayed in the middle location between the maximum attribute value and the minimum attribute value. As shown in an example diagram 500 for the filtering bar illustrated by FIG. 5, the sorting attribute is “price”, and the highest price of the business objects displayed on the webpage is 10 while the lowest price is 500. If three attribute values, including the maximum attribute value and the minimum attribute value, need to be displayed on the filtering bar, the prices “10” and “500” are displayed at the two terminal of the filtering bar. If the attribute value other than the maximum attribute value and the minimum attribute value is an attribute value between these two values, the price “245” can be displayed in the middle of the filtering bar.

Further, Embodiment 1 also provides an example method of displaying attribute values on the filtering bar. For user's adjustment, cursors corresponding to the number of attribute values to be displayed can be set on the filtering bar and the attribute values are displayed on the corresponding cursors.

It should be understood that displaying at least two attribute values of the attribute values on the filtering bar is merely an exemplary method. In applications, one attribute value can be displayed on the filtering bar, and the adjustment of the filtering range of the attribute value when the displayed attribute value moves along the different directions can be determined. For example, the two terminals of the default filtering bar correspond to the two limit values of the sorting attributes of all business object on the webpage (for instance, the maximum value and the minimum value, or the best value and the worst value), and the range composed of the attribute values displayed on the filtering bar and the default attribute value of one terminal of the filtering bar is set as the initial filtering range. The initial filtering range can be adjusted according to the moving direction of the displayed attributed value. The specific adjustment principles are the same as the aforementioned adjustment principle and are omitted here.

According to the method of displaying attribute values on the filtering bar provided by Embodiment 1, the same or different method of displaying the filtering bar can be set for different sorting attributes, and the configured information of the display method may comprise the number of attribute values displayed on the filtering bar, the conditions that the displayed attribute values need to meet, and the display locations of the displayed attribute values on the filtering bar, etc. For example, for the sorting attribute “price”, the possible method of configuring the display of the filtering bar include: displaying two attribute values on the filtering bar, the two attribute values are the maximum value and the minimum value of the prices, and the maximum value and the minimum value are displayed on the two terminals of the filtering bar.

For better understanding the specific process of the operation 404 in the present embodiment, the process is explained in conjunction with example application scenarios.

In the scenario, the method of configuring the display of the filtering bar include: displaying two attribute values on the filtering bar, and displaying the maximum value and the minimum value.

Based on the aforementioned scenario, in operation 404, the client terminal displays the filtering bar on the webpage based on the set filtering bar according to the attribute values of sorting attributes corresponding to the business objects contained on the current webpage. In other words,

The client terminal displays the maximum value and the minimum value of the displayed attribute values on the two terminal of the filtering bar according to the attribute values of sorting attributes corresponding to the business objects contained on the current webpage.

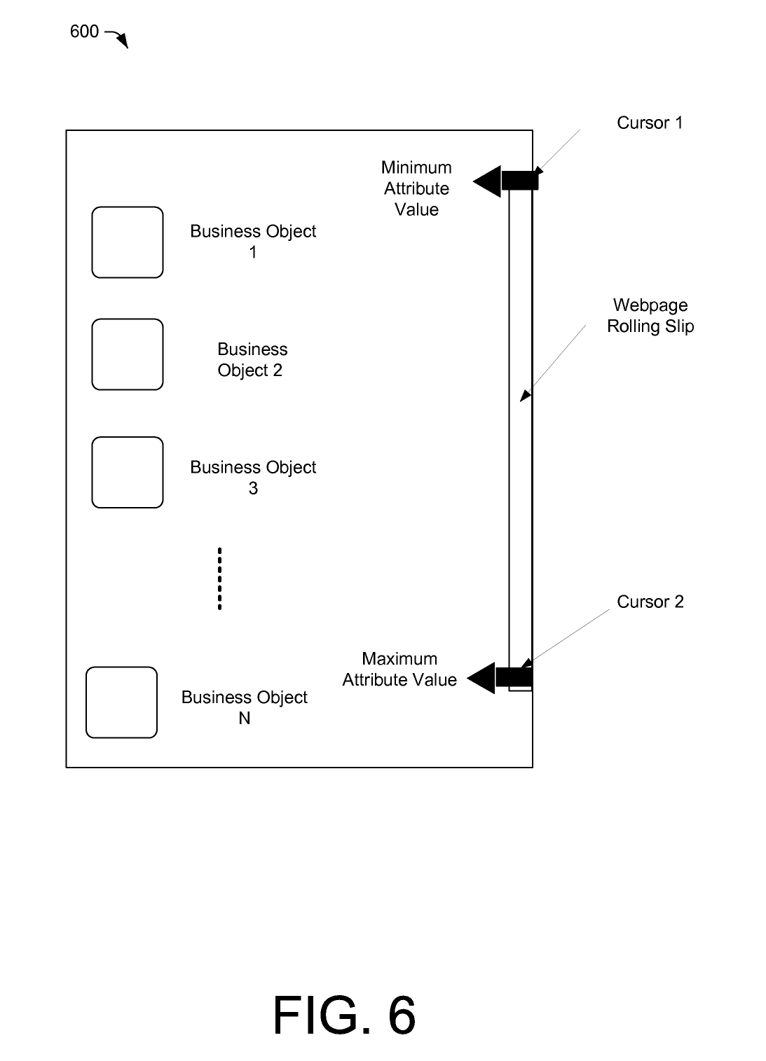

FIG. 6 presents an example diagram 600 for displaying attribute values based on the filtering bar under the aforementioned scenario. As seen in FIG. 6, the webpage contains n business objects, and two cursors (cursor 1, cursor 2) are set on the filtering bar, wherein cursor 1 indicates the minimum value and cursor 2 indicates the maximum value. The minimum value is the minimum value of the attribute values corresponding to the sorting attributes of the n business objects contained on the webpage, and the maximum value is the maximum value of the attribute values corresponding to the sorting attributes of the n business objects contained on the webpage.

According to the technical solution provide by Embodiment 1, when the user triggers the function of filtering attribute values based on the filtering bar, the client terminal can display an interface, as illustrated in FIG. 6, on the webpage. The user can adjust the filtering range of the attribute values of sorting attributes according to the attribute values displayed on the two terminal of the filtering bar by moving the locations of the attribute values on the filtering bar.

In operation 406 contained in the flow presented in FIG. 4, the operations performed by attribute values displayed on the filtering bar mainly direct to the operations to the attribute values displayed on the filtering bar performed by the user. Specifically, the operations to the attribute values displayed on the filtering bar performed by the user comprise:

At least one attribute value of the attribute values displayed on the filtering bar is dragged.

For example, in the interface shown in FIG. 6, the user can drag the locations of cursor 1 or cursor 2 on the filtering bar, or drag the locations of cursor 1 and cursor 2 on the filtering bar simultaneously. For example, on a terminal supporting a touch screen, the user can adjust the locations of cursor 1 and cursor 2 on the filtering bar simultaneously by dragging cursor 1 and cursor 2.

Correspondingly, the filtering range of the attribute values of sorting attributes is determined according to the performed operations of the attribute values displayed on the filtering bar. Specifically, if an attribute value displayed at one terminal of the filtering bar is dragged, the attribute value displayed at that terminal is adjusted so as to determine the filtering range of the attribute values of sorting attributes; if two attribute values displayed at two terminals of the filtering bar are both dragged, the attribute values displayed at two terminals are adjusted so as to determine the filtering range of the attribute values of sorting attributes. For example, in the interface shown in FIG. 6, if only cursor 1 is moved, the filtering range is determined based on the moving condition of cursor 1; if only cursor 2 is moved, the filtering range is determined based on the moving condition of cursor 2; if both cursor 1 and cursor 2 are moved, the filtering range is determined based on the moving conditions of cursor 1 and cursor 2 respectively.

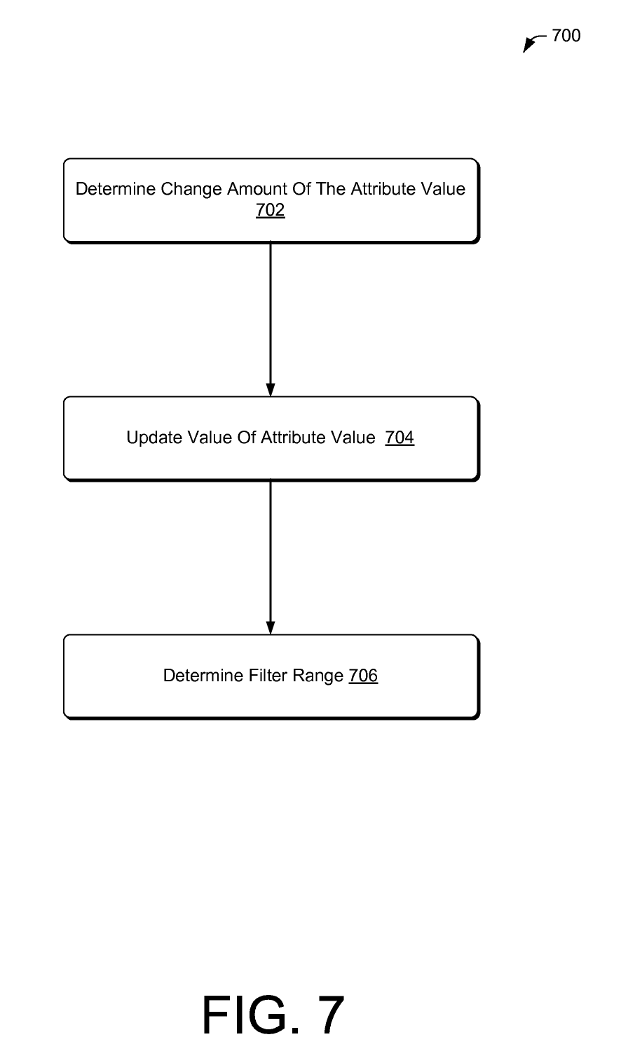

FIG. 7 illustrates an example flow chart 700 for a client terminal determining a filtering range of the attribute values of sorting attributes according to operations of dragging the attribute values. At 702, for each dragged attribute value, determining a change amount of the attribute value according to a range of the attribute value being dragged.

In some instances, the range of the attribute value being dragged and displayed on the filtering bar is the range in which the attribute value changes the location on the filtering bar after the user drags the attribute value. The change amount of the attribute value is the change amount between the value corresponding to the location before the attribute value is dragged and the value corresponding to the location after the attribute value is dragged.

At 704, a value of the attribute value is updated before being dragged according to the change amount of each dragged attribute value.

At 706, the filtering range of the attribute values of sorting attributes is determined according to an updated value of each dragged attribute value.

The process of a client terminal determining a filtering range of the attribute values of sorting attributes according to operations of dragging the attribute values ends here.

By performing the operations shown in FIG. 7, the filtering range of the attribute values of sorting attributes can be easily determined according to the dragging operations performed by the user to the attribute values displayed on the filtering bar.

For example, in operation 702, determining a change amount of the attribute value according to a range of the attribute value being dragged can be implemented by the following: determining the corresponding change amount after the attribute value being dragged for the range according to the range of the attribute value being dragged and a distribution status of the attribute values of sorting attributes on the rolling bar.

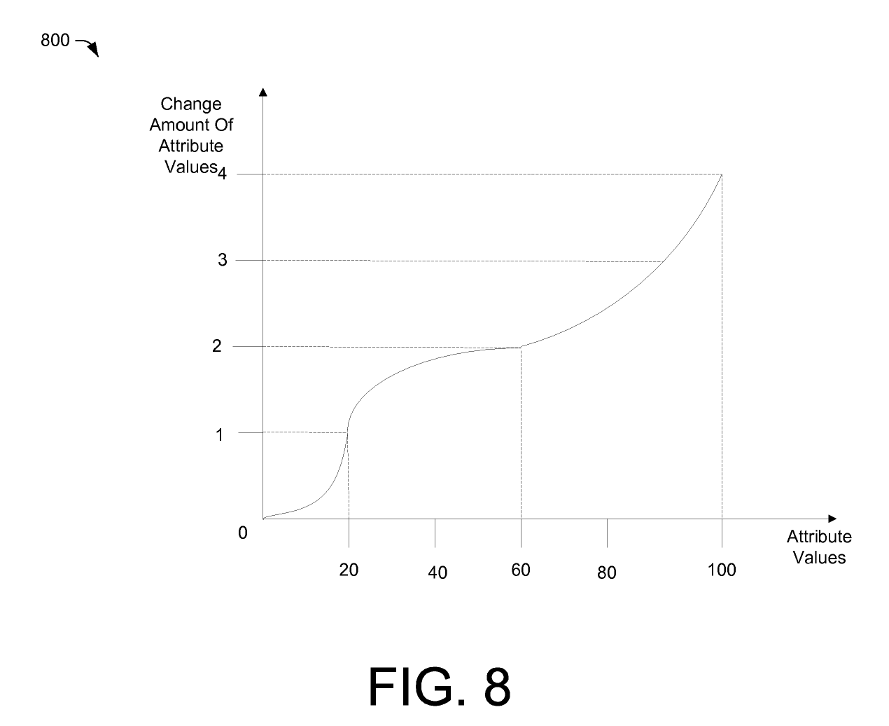

In some instances, a distribution status of the attribute values of sorting attributes on the rolling bar can be determined according to the number of the business objects corresponding to the different attribute values (or the intervals of attribute values) of sorting attributes. For example, for the sorting attribute of “the creditability of the provider of the business objects”, the maximum attribute value of the business objects displayed on the webpage (the highest creditability) is 100, and the minimum attribute value (the lowest creditability) is 0. When the creditability is a different value, the number of the distributed business objects is different. Thus, the distribution status of the attribute values of sorting attributes on the rolling bar can be determined. For example, if the number of business objects corresponding to a certain interval of attribute values is smaller, it can determine that in the distribution status, the attribute value changes more when it moves in the interval; if the number of business objects corresponding to a certain interval of attribute values is greater, it can determine that in the distribution status, the attribute value changes less when it moves in the interval. An example diagram 800 for the distribution status is shown as the curve of FIG. 8. If the dragging range of the attribute value is from 0 to 1, the change amount of the attribute value is 20, and if the dragging range of the attribute value is from 0 to 2, the change amount of the attribute value is 60, and so on.

It should be understood that the distribution status presented in FIG. 8 is merely exemplary. In applications, the distribution status can be determined according to various real situations of the sorting attributes.

In another example embodiment, the distribution status can be proportional. In other words, the change amount of the attribute value after the attribute value being moved can be determined according to the range of the attribute value moves and the change amount of the attribute value on the unit length of the filtering bar. For example, the total range interval of the attribute value of the business object contained on the webpage is 0 to 100 before the filtering bar is operated, the length of the filtering bar is 5 cm, the change amount of the attribute value on the unit length of the filtering bar is 100/5=20. As such, when the filtering range indicated by the attribute value before it is dragged is 0 to 100, after the attribute value “0” is dragged by 2 cm, the attribute value is updated as “40”, and the updated filtering range is “40 to 100”.

For example, in operation 704, updating a value of the attribute value before being dragged according to the change amount of each dragged attribute value can be implemented in the following manner: determining an increase/decrease attribute of the attribute value according to a direction of the attribute value being dragged; and increasing or decreasing of the value before the attribute value being dragged by the change amount according to the increase/decrease attribute.

For example, in the interface illustrated in FIG. 6, the range indicated by cursor 1 and cursor 2 is “0 to 100”. If cursor 1 moves close to cursor 2 and the change amount is 40, the increase/decrease attribute of the attribute value is “increase”, and the filtering range after the movement is “40 to 100”; if later another user moves cursor 1 far away from cursor 2 and the change amount is 20, the increase/decrease attribute of the attribute value is “decrease”, and the filtering range after the movement is “20 to 100”.

The detailed explanation of the process of filtering business objects is given by the embodiments. Based on the above filtering process, the user can quickly implement the configuration of filtering criteria by moving the attribute values displayed on the filtering bar, which can dramatically reduce the steps of inputting the filtering information and the work load of inputting, and consequently reduce the time of filtering business objects. Also it facilitates the user's operations and in particular is suitable for the operations of certain equipment, such as a touch screen.

### Embodiment 2

Corresponding to the operations provided in Embodiment 1, the present Embodiment 2 provides a device of filtering business objects. With such a device, the time of filtering process is shortened, and the efficiency of filtering business objects is increased.

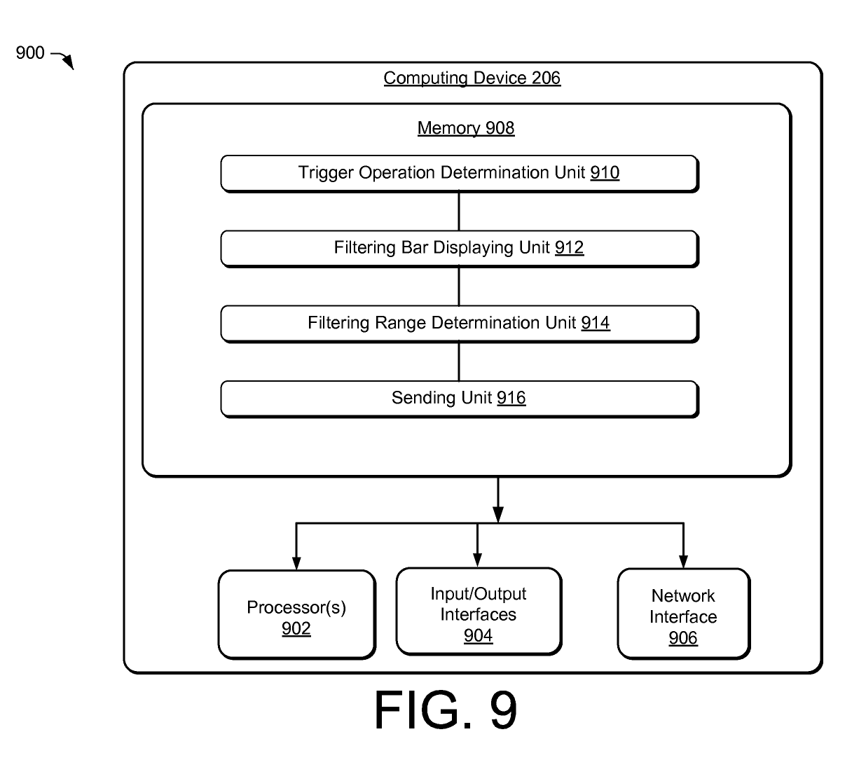

FIG. 9 is an example diagram 900 for a device of filtering business objects in accordance with Embodiment 2 of the present disclosure. FIG. 9 illustrates an example of the computing device 206 or the server 208 (not shown) that may be deployed in the architecture of FIG. 2. In one exemplary configuration, the computing device 206 includes one or more processors 902, input/output interfaces 904, network interface 906, and memory 908.

The memory 908 may include computer-readable media in the form of volatile memory, such as random-access memory (RAM) and/or non-volatile memory, such as read only memory (ROM) or flash RAM. The memory 908 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 908 in more detail, the memory 908 may include a trigger operation determination unit 910, a filtering bar displaying unit 912, a filtering range determination unit 914, and a sending unit 916.

In some instances, the trigger operation determination unit 910 is configured to determine that a user terminal is performed an operation of triggering of filtering business objects. The filtering bar displaying unit 912 is configured to, after the trigger operation determination unit 910 determines the operation, display a filtering bar on a current webpage, wherein the filtering bar displays attribute values, and the displayed attribute values are determined based on attribute values of sorting attributes corresponding to business objects contained in the current webpage. The filtering range determination unit 914 is configured to determining a filtering range of the attribute values of sorting attributes according to operations performed by attribute values displayed on the filtering bar. The sending unit 916 is configured to send the determined filtering rage information to a webpage server.

In some instances, the filtering bar displaying unit 912 of the device shown in FIG. 9 is specifically for displaying at least two attribute values of the attribute values on the filtering bar according to attribute values of sorting attributes corresponding to business objects contained in the current webpage. In some instances, the filtering bar displaying unit 912 of the device shown in FIG. 9 is specifically for displaying at least a maximum attribute value and a minimum attribute value of the attribute values on the filtering bar according to attribute values of sorting attributes corresponding to business objects contained in the current webpage.

In some instances, the filtering bar displaying unit 912 of the device shown in FIG. 9 is for displaying at least the maximum attribute value and the minimum attribute value of the at least two attribute values on two terminals of the filtering bar. In some instances, the filtering bar displaying unit 912 of the device shown in FIG. 9 is specifically for setting cursors corresponding to a number of attribute values to be displayed on the filtering bar and displaying attribute values corresponding to the set cursors.

In some instances, the trigger operation determination unit 910 of the device shown in FIG. 9 is for determining the user terminal is performed the operation of at least one attribute value of the attribute values displayed on the filtering bar is dragged.

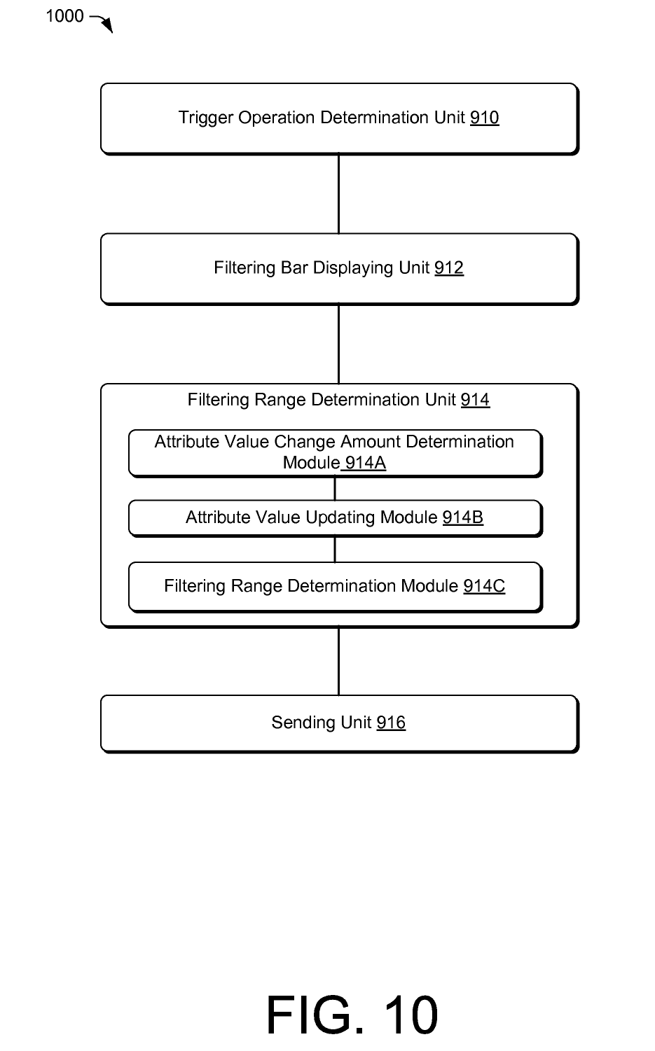

As shown in FIG. 10, the filtering range determination unit 914 of the device shown in FIG. 9 further comprises an attribute value change amount determination module 914A, an attribute value updating module 914B and a filtering range determination module 914C.

The attribute value change amount determination module 914A is configured to, for each dragged attribute value, determine a change amount of the attribute value according to a range of the attribute value being dragged.

The attribute value updating module 914B is configured to update a value of the attribute value before being dragged according to the change amount of the attribute value determined by the attribute value change amount determination module.

The filtering range determination module 914C is configured to determine the filtering range of the attribute values of sorting attributes according to an updated value of each dragged attribute value updated by the attribute value updating module.

In some instances, the attribute value change amount determination module 914A shown in FIG. 10 is for, for each dragged attribute value, determining the corresponding change amount after the attribute value being dragged for the range according to the range of the attribute value being dragged and a distribution status of the attribute values of sorting attributes on the rolling bar.

In some instances, the attribute value updating module 914B shown in FIG. 10 is specifically for determining an increase/decrease attribute of the attribute value according to a direction of the attribute value being dragged; and increasing or decreasing of the value before the attribute value being dragged by the change amount according to the increase/decrease attribute.

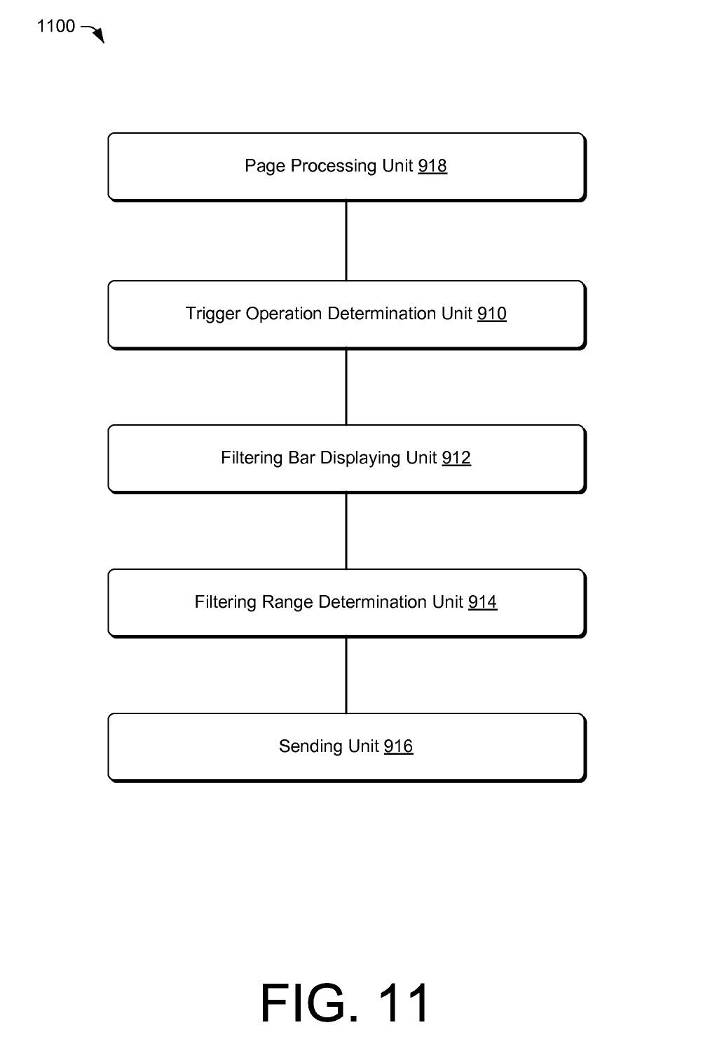

As shown in FIG. 11, in one example embodiment, the device of FIG. 9 can further comprise a page processing unit 918 configured to, before the trigger operation determination unit determines that a user terminal has performed an operation of triggering of filtering business objects, receive a search request submitted by the user from the user terminal and send the search request to the webpage server; and receive business object data determined by the webpage server according to the search request and display business objects corresponding to the business object data through a webpage.

In some instances, the page processing unit 918 of the device shown in FIG. 11 is also for after displaying business objects corresponding to the business object data through a webpage, displaying a number of business objects contained in the current webpage in a set location of a webpage.

In some instances, the page processing unit 918 of the device shown in FIG. 11 is also for after displaying a business object corresponding to the business object data through a webpage and before determining that a user terminal is performed an operation of triggering of filtering business objects, receiving a sorting request submitted by the user from the user terminal; and sorting business objects on the webpage according to sorting attributes of the sorting request.

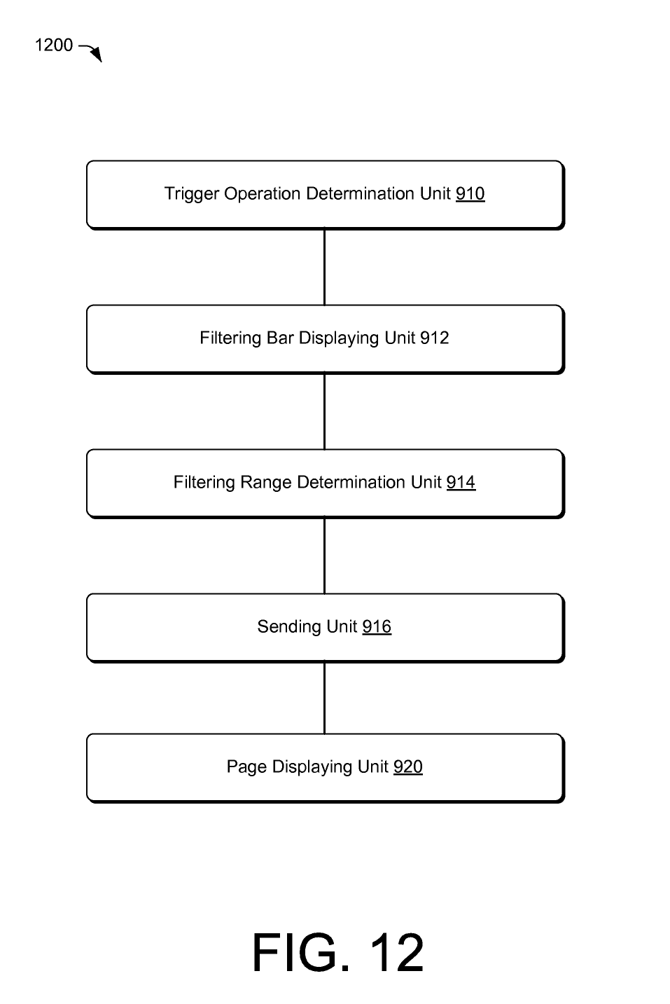

As shown in FIG. 12, in one preferred embodiment, the device of FIG. 9 can further comprise a page displaying unit 920 configured to, after the sending unit sends the determined filtering rage information to a webpage server, receive business object data determined by the webpage server according to the filtering range and displaying business objects corresponding to the business object data through a webpage.

In some instances, page displaying unit 920 of the device shown in FIG. 12 is also configured to, after displaying business objects corresponding to the business object data through a webpage, display a number of business objects contained in the current webpage in a set location of a webpage.

The functions of the units and/or module of the device of filtering business objects shown in FIGS. 9-12 may correspond to the process steps performed on the client's terminal in Embodiment 1 and are omitted here for the sake of clarity.

The device of filtering business objects provided by Embodiment 2 can be in a user's terminal. Furthermore, it can be in a client browser of the user's terminal.

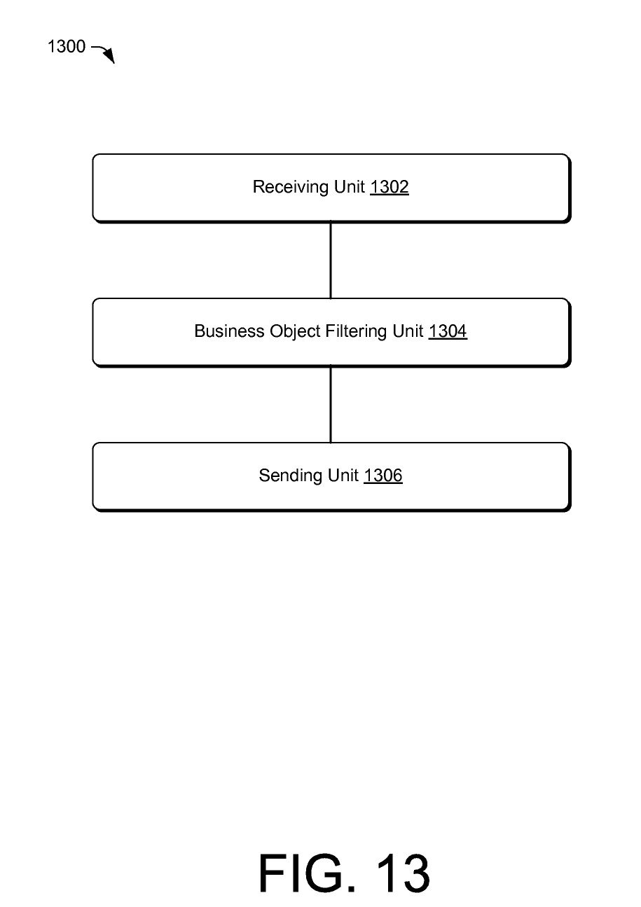

FIG. 13 illustrates another logic structure of a device of filtering business objects provided by Embodiment 2. As shown in FIG. 13, the device comprises a receiving unit 1302 configured to receive a range of filtering of attribute values of sorting attributes of business objects contained in a webpage which is sent from a user terminal, wherein the range of filtering of attribute values of sorting attributes is determined according to operations performed by attribute values displayed on a filtering bar, and the attribute values displayed on the filtering bar are determined by attribute values of sorting attributes corresponding to business objects contained in a current webpage.

The device may also comprise a business object filtering unit 1304 configured to, according to the range of filtering of the received attribute values of sorting attributes, determine business object data corresponding to the range of filtering, and send the determined business object data to the user terminal; and a sending unit 1306 configured to send the business object data determined by the business object filtering unit to the user terminal.

The functions of the units and/or module of the device of filtering business objects shown in FIG. 13 may correspond to the process steps performed on the client's terminal in Embodiment 1 and are omitted here for the sake of clarity. The device of filtering business objects provided by Embodiment 2 can be in a website server.

The device of filtering business objects provided by Embodiment 2, shown in FIGS. 9-13, can be implemented by computer programs. People skilled in the art should understand that the aforementioned division of function units is merely one type of various divisions. The device divided as different unit or not divided are still in the scope of the present disclosure as long as the device of filtering business objects have the aforementioned functions.

Persons skilled in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be saved in other computer-readable storage which can instruct a computer or other programmable data processors to operate in a certain way, so that the instructions saved in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The present disclosure presents a method and a device of filtering business objects. After determining that a user terminal has performed an operation of triggering of filtering business objects, displaying a filtering slip on a current webpage, wherein the filtering slip displays attribute values, and the displayed attribute values are determined based on attribute values of sorting attributes corresponding to business objects contained in the current webpage; further, after displaying the filtering slip on the current webpage, determining a filtering range of the attribute values of sorting attributes according to operations performed by attribute values displayed on the filtering slip; and sending the determined filtering rage information to a webpage server. The present disclosure can display a filtering slip on a webpage for a user's operation after a filtering operation triggered by the user is monitored, so that the user can perform operations to the filtering slip directly to adjust the filtering range of the attribute values. Compared to the conventional technology, the present disclosure eliminates the operations that the user inputs filtering criteria in the specified input box of a webpage. Instead, the method performs operations on the filtering criteria directly to adjust the filtering range of the attribute values. As such, the user operations are simplified, the time of filtering process is shortened, and the efficiency of filtering business objects is increased.

The embodiments described above are only preferred embodiments of the present application. It should be noted that numerous improvements and modifications can be made by those skilled in the present art without departing from the principles of the present application, and these improvements and modifications should be deemed as falling within the scope of protection of the present application.

What is claimed is:

1. A method of filtering business objects, comprising:
determining that a user terminal is performed an operation of triggering of filtering business objects;
displaying a filtering slip on a current webpage, wherein the filtering slip displays attribute values, and the displayed attribute values are determined based on attribute values of sorting attributes corresponding to business objects contained in the current webpage;
determining a filtering range of the attribute values of sorting attributes according to operations performed by attribute values displayed on the filtering slip; and
sending the determined filtering rage information to a webpage server.

2. The method as recited in claim 1, wherein the determining attribute values displayed on the filtering slip based on attribute values of sorting attributes corresponding to business objects contained in the current webpage comprises:
displaying at least two attribute values of the attribute values on the filtering slip according to attribute values of sorting attributes corresponding to business objects contained in the current webpage.

3. The method as recited in claim 2, wherein the at least two attribute values comprise:
a maximum attribute value and a minimum attribute value of the attribute values.

4. The method as recited in claim 3, wherein the displaying the at least two attribute values of the attribute values on the filtering slip comprises:
displaying the maximum attribute value and the minimum attribute value of the at least two attribute values on two terminals of the filtering slip.

5. The method as recited in any claim of claim 4, wherein the displaying attribute values on the filtering slip comprises:
setting cursors corresponding to a number of attribute values to be displayed on the filtering slip and displaying attribute values corresponding to the set cursors.

6. The method as recited in any claim of claim 4, wherein the performed operation of attribute values displayed on the filtering slip comprises:
at least one attribute value of the attribute values displayed on the filtering slip is dragged.

7. The method as recited in claim 6, wherein the determining a filtering range of the attribute values of sorting attributes according to operations performed by attribute values displayed on the filtering slip comprises:
for each dragged attribute value, determining a change amount of the attribute value according to a range of the attribute value being dragged, and updating a value of the attribute value before being dragged according to the change amount of the attribute value; and
determining the filtering range of the attribute values of sorting attributes according to an updated value of each dragged attribute value.

8. The method as recited in claim 7, wherein determining a change amount of the attribute value according to a range of the attribute value being dragged comprises:
determining the corresponding change amount after the attribute value being dragged for the range according to the range of the attribute value being dragged and a distribution status of the attribute values of sorting attributes on a rolling slip.

9. The method as recited in claim 8, wherein updating a value of the attribute value before being dragged according to the change amount of the attribute value comprises:
determining an increase/decrease attribute of the attribute value according to a direction of the attribute value being dragged; and
increasing or decreasing of the value before the attribute value being dragged by the change amount according to the increase/decrease attribute.

10. The method as recited in claim 1, wherein before determining that a user terminal is performed an operation of triggering of filtering business objects, further comprises:
receiving a search request submitted by the user from the user terminal and sending the search request to the webpage server; and
receiving business object data determined by the webpage server according to the search request and displaying business objects corresponding to the business object data through a webpage.

11. The method as recited in claim 10, wherein after displaying a business object corresponding to the business object data through a webpage and before determining that a user terminal is performed an operation of triggering of filtering business objects, further comprises:
receiving a sorting request submitted by the user from the user terminal; and
sorting business objects on the webpage according to sorting attributes of the sorting request.

12. The method as recited in claim 1, wherein after sending the determined filtering rage information to a webpage server, further comprises:
receiving business object data determined by the webpage server according to the filtering range and displaying business objects corresponding to the business object data through a webpage.

13. The method as recited in claim 12, wherein after displaying business objects corresponding to the business object data through a webpage, further comprises:
displaying a number of business objects contained in the current webpage in a set location of a webpage.

14. A method of filtering business objects, comprising:
receiving a range of filtering of attribute values of sorting attributes of business objects contained in a webpage which is sent from a user terminal, wherein the range of filtering of attribute values of sorting attributes is determined according to operations performed by attribute values displayed on a filtering slip, and the attribute values displayed on the filtering slip are determined by attribute values of sorting attributes corresponding to business objects contained in a current webpage;
according to the range of filtering of the received attribute values of sorting attributes, determining business object data corresponding to the range of filtering, and sending the determined business object data to the user terminal.

15. A device of filtering business objects, comprising:
a trigger operation determination unit for determining that a user terminal is performed an operation of triggering of filtering business objects;
a filtering slip displaying unit for, after the trigger operation determination unit determining the operation displaying a filtering slip on a current webpage, wherein the filtering slip displays attribute values, and the displayed attribute values are determined based on attribute values of sorting attributes corresponding to business objects contained in the current webpage;
a filtering range determination unit for determining a filtering range of the attribute values of sorting attributes according to operations performed by attribute values displayed on the filtering slip; and
a sending unit for sending the determined filtering rage information to a webpage server.

16. The device as recited in claim 15, wherein the filtering slip displaying unit is for displaying at least two attribute values of the attribute values on the filtering slip according to attribute values of sorting attributes corresponding to business objects contained in the current webpage.

17. The device as recited in claim 16, wherein the trigger operation determination unit is for determining the user terminal is performed the operation of at least one attribute value of the attribute values displayed on the filtering slip is dragged.

18. The device as recited in claim 17, wherein the filtering range determination unit comprises:
an attribute value change amount determination module for, for each dragged attribute value, determining a change amount of the attribute value according to a range of the attribute value being dragged;
an attribute value updating module for updating a value of the attribute value before being dragged according to the change amount of the attribute value determined by the attribute value change amount determination module; and
a filtering range determination module for determining the filtering range of the attribute values of sorting attributes according to an updated value of each dragged attribute value updated by the attribute value updating module.

19. The device as recited in claim 15, further comprises:
a page processing unit for, before the trigger operation determination unit determining that a user terminal is performed an operation of triggering of filtering business objects, receiving a search request submitted by the user from the user terminal and sending the search request to the webpage server; and receiving business object data determined by the webpage server according to the search request and displaying business objects corresponding to the business object data through a webpage.

20. The device as recited in claim 15, further comprises:
a page displaying unit for, after the sending unit sending the determined filtering rage information to a webpage server, receiving business object data determined by the webpage server according to the filtering range and displaying business objects corresponding to the business object data through a webpage.

21. A device of filtering business objects, comprising:
a receiving unit for receiving a range of filtering of attribute values of sorting attributes of business objects contained in a webpage which is sent from a user terminal, wherein the range of filtering of attribute values of sorting attributes is determined according to operations performed by attribute values displayed on a filtering slip, and the attribute values displayed on the filtering slip are determined by attribute values of sorting attributes corresponding to business objects contained in a current webpage;
a business object filtering unit for, according to the range of filtering of the received attribute values of sorting attributes, determining business object data corresponding to the range of filtering, and sending the determined business object data to the user terminal; and
a sending unit for sending the business object data determined by the business object filtering unit to the user terminal.
